(19) United States
(12) Patent Application Publication
(10) Pub. No.: US 2006/0117008 A1
(43) Pub. Date: Jun. 1, 2006

(54) File management apparatus and file management program

(75) Inventor: Nobuhiro Shimogori, Kawasaki-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Chiyoda-ku (JP)

(21) Appl. No.: 10/991,623

(22) Filed: Nov. 17, 2004

(51) Int. Cl. G06F 7/00

(52) U.S. Cl. 707/7

(57) ABSTRACT

A file management apparatus and a file management program are provided which are capable of reflecting, upon occurrence of updates of files in a group of files to be managed the updates in an appropriate manner without the need to perform complicated or troublesome work, as well as achieving effective file searches irrespective of the kinds or types of the files. The apparatus includes a file information acquisition section that acquires file information in the form of information on each of a plurality of files to be managed at predetermined timing; a change-of-state detection section that detects at least either one of new creation, update and deletion as a change of state in each of the plurality of files based on the latest file information acquired at the latest timing and immediately preceding file information acquired at timing immediately before the latest timing; a file time point setting section that sets, upon detection of a change of state in any of the files by the change-of-state detection section, a specific time point with respect to the file, for which the change of state was detected, based on a predetermined rule corresponding to the change of state; and a file management section that orders the plurality of files based on the specific time points that are set to the plurality of files, respectively, by the file time point setting section.

### BACKGROUND OF THE INVENTION

1. Field of the Invention

The present invention relates to a file management apparatus and a file control program for managing a plurality of pieces of file data.

2. Description of the Related Art

In the past, in order to find out target file data (hereinafter called a file) from a plurality of pieces of file data (data such as document files, image or graphic files, etc.) stored in memory areas, there have been used a method of making a search by the file name or date of the file concerned, a method of searching for files that contain a specific word through a keyword search, a method of making a search based on the classification of files, etc.

In these methods, there is a problem in that a user should recall information in the form of clues to search for a target file, and in case where information thus recalled is inaccurate, the target file is not easily found.

In addition, there is a further method of making a search by the use of a list of small images called thumbnails, too, which is effective when distinctions among files can be recognized at a glance even with small image representations such as image files of photographs. However, it is difficult to identify a target document among character-based files with similar layouts such as document files.

To solve the problems as referred to above, there has been disclosed an information search method in which files are sorted in the order of the newest to oldest last search dates or last update dates thereof, and sequentially searched for and displayed according to the sorted order, and the search is stopped at the time when the image of the target file is displayed (Japanese patent application laid-open No. H5-54081).

In the above-mentioned information search method, however, there is a problem that when a user updates the information of a file, unless the update is carried out on a system that achievers the above information search method, the information of the file registered on the system concerned and the index information thereof will cause mismatch or inconsistency with the updated content thereof.

For example, in case where the files, being frequently updated by users, are managed on a system that achieves the above-mentioned information search method, if a user updates a file registered on the above-mentioned system in places other than the system, the updated content might not be reflected on that system, so a search after the update could not provide a correct search result. In addition, when a user frequently creates files, it becomes necessary to register the files on the above-mentioned system every time the files are created, thus causing a problem that the user's work becomes complicated and troublesome.

Moreover, since the update date of a file managed in a file system might be set to a date different from the actually updated date thereof depending upon an application program used, the update date does not necessarily become the date on which the user updated or created the file. For example, there is a case where an attached file received through e-mail is set to the date on which a file sender created or updated the file, while the point in time at which a receiver saved the file on his or her own PC is not recorded.

### SUMMARY OF THE INVENTION

The present invention is intended to obviate the problems as referred to above, and has for its object to provide a file management apparatus and a file management program which are capable of reflecting, upon occurrence of updates of files in a group of files to be managed, the updates in an appropriate manner without the need to perform complicated or troublesome operation, as well as achieving effective file searches irrespective of the kinds or types of the files.

In order to solve the above-mentioned problems, a file management apparatus according to the present invention is constructed to comprise a file information acquisition section that acquires file information in the form of information on each of a plurality of files to be managed at predetermined timing; a change-of-state detection section that detects at least either one of new creation, update and deletion as a change of state in each of the plurality of files based on latest file information acquired at latest timing and immediately preceding file information acquired at timing immediately before the latest timing; a file time point setting section that sets, upon detection of a change of state in any of the files by the change-of-state detection section, a specific time point with respect to the file, for which the change of state was detected, based on a predetermined rule corresponding to the change of state; and a file management section that orders the plurality of files based on the specific time points that are set to the plurality of files, respectively, by the file time point setting section.

A file management program according to the present invention is constructed so as to make a computer execute: a file information acquisition step of acquiring file information in the form of information on each of a plurality of files to be managed at predetermined timing; a change-of-state detection step of detecting at least either one of new creation, update and deletion as a change of state in each of the plurality of files based on latest file information acquired at latest timing and immediately preceding file information acquired at timing immediately before the latest timing; a file time point setting step of setting, upon detection of the change of state in the change-of-state detection step, a specific time point with respect to the file for which the change of state was detected, based on a predetermined rule corresponding to the change of state; and a file management step of ordering the plurality of files based on the specific time points that are set to the plurality of files, respectively, in the file time point setting step.

### BRIEF DESCRIPTION OF THE DRAWINGS

FIG. 1 is a functional block diagram illustrating the construction of a file management apparatus according to this embodiment.

FIG. 2 is a view illustrating an example of the latest file list stored in a list storage section 103.

FIG. 3 is an example of the last but one (immediately preceding) file list stored in the list storage section 103.

FIG. 4 is a view illustrating the comparison result of file lists passed to a file time point setting section 105.

FIG. 5 is a view illustrating the state in which file time points were specified by the file time point setting section 105 in the comparison result of the file lists.

FIG. 6 is a view illustrating details of information on the files stored in a file information storage section 107.

FIG. 7 is a view illustrating the contents of a file list in a state where the comparison result of the file lists is reflected thereon.

FIG. 8 is a view illustrating the file information which is ordered according to file time points by the file management section 106, and which is stored in the file information storage section 107.

FIG. 9 is a flow chart illustrating steps from the detection of update of a file stored in the file storage section 102 until the rendering of a print image is completed.

FIG. 10 is a flow chart for explaining in detail the operation (S804) of the file time point setting section 105.

FIG. 11 is a flow chart for explaining the flow of processing as a whole in the file management apparatus.

### DESCRIPTION OF THE EMBODIMENT

Hereinafter, a preferred embodiment of the present invention will be described in detail while referring to the accompanying drawings.

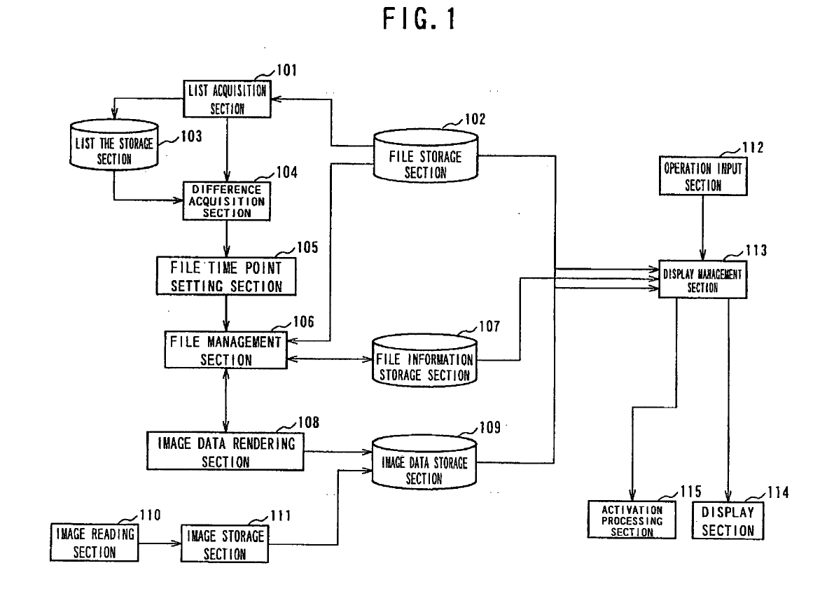

FIG. 1 is a functional block diagram that illustrates the construction of a file management apparatus according to this embodiment.

As illustrated in this figure, the file management apparatus according to this embodiment is constructed to include a list acquisition section (file information acquisition section) 101, a file storage section 102, a list storage section 103, a difference acquisition section 104, a file time point setting section 105, a file management section 106, a file information storage section 107, an image data rendering section 108, an image data storage section (predetermined storage area) 109, an image reading section 110, an image storage section 111, an operation input section 112, a display management section 113, a display section 114, an activation processing section 115, an unillustrated storage section, and an unillustrated control section.

The file storage section 102 has a role to store a plurality of pieces of file data to be managed (data such as document files, image or graphic files, data files, etc.) (corresponding to a plurality of files) in this apparatus.

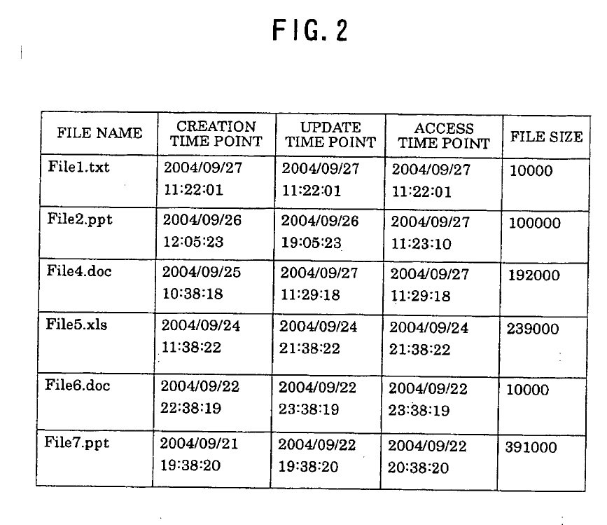

The list acquisition section 101 has a role to acquire a list of the file names of the plurality of files stored in the file storage section 102 at predetermined timing together with their file creation time points, the last update time points, the last access time points, and their file sizes. The list acquisition section 101 stores the list thus acquired in the list storage section 103 together with a list acquisition time point. FIG. 2 illustrates an example of the file list (corresponding to the file information) stored in the list storage section 103 (the latest file list acquired at 11:30:00, Sep. 27, 2004). The list acquisition section 101 passes the acquired latest file list to the difference acquisition section 104.

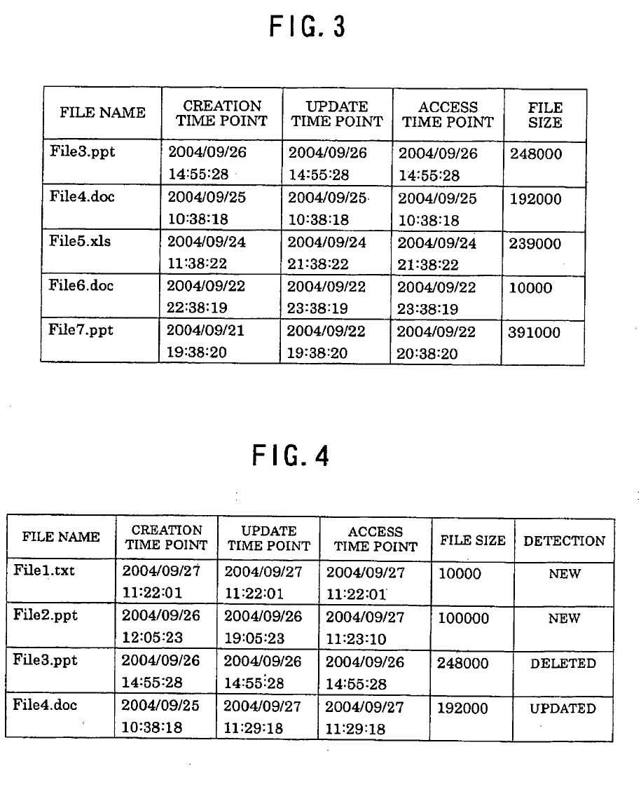

Upon receipt of the latest file list (file information acquired at the latest timing), the difference acquisition section 104 acquires, among the lists stored in the list storage section 103, the file list (file information acquired last time) that was acquired immediately before the latest file list. FIG. 3 illustrates an example of the last but one (immediately preceding) file list (file list acquired at 10:20:00 on Sep. 27, 2004) in the list storage section 103.

Then, the difference acquisition section (corresponding to a change-of-state detection section) 104 compares the latest file list with the immediately preceding file list, and verifies whether records with the same file name and the same update time point are included in both of the lists (a change-of-state detection step). Those files which are included in the latest file list (e.g., one acquired at 11:30:00 on Sep. 27, 2004) but not in the immediately preceding file list (i.e., one acquired at 10:20:00 on Sep. 27, 2004) are marked with an indication “new”. Those files which have the same file names included in both of the latest file list and the immediately preceding file list but are different in the last update time points are marked with an indication “updated”. Those files which are included in the immediately preceding file list but not in the latest file list are marked with an indication “deleted”, and only the files attached with the marks are passed to the file time point setting section 105 together with the immediately preceding file list collection time point (10:20:00, Sep. 27, 2004) and the latest file list collection time point (11:30:00, Sep. 27, 2004). FIG. 4 illustrates the comparison result of the file lists passed to the file time point setting section 105. As shown in this figure, marks such as “new”, “updated” and “deleted” are recorded in “detection” fields. Thus, the difference acquisition section 104 has a role to detect at least either one of new creation, update and deletion as a change of state in each of the plurality of files based on the latest file information acquired at the latest timing and the immediately preceding file information acquired at the timing immediately before the latest timing. That is, in the list acquisition section 101, the change of state in each of the plurality of files are detected based on the last update time point of each file acquired at the latest timing and the last update time point of each file acquired at the timing immediately before the latest timing.

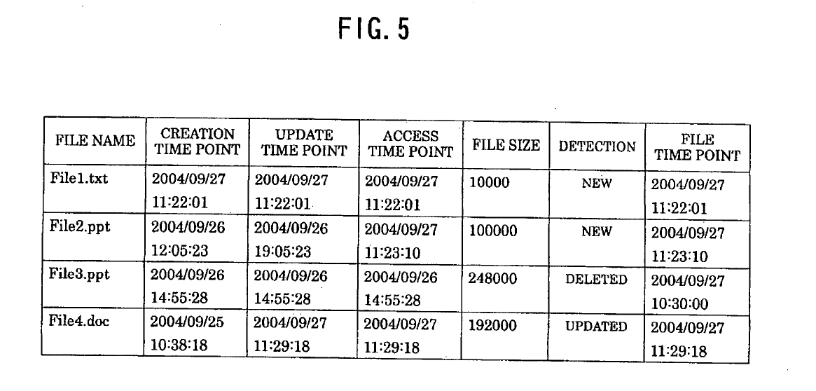

The file time point setting section 105 specifies a file time point that becomes a reference when the files are ordered or sorted based on the above-mentioned comparison result of the file lists (a file time point setting step). If the last update time point of a file marked with “new” in the file list lies between the immediately preceding file list collection time point and the latest file list collection time point, it is set as the file time point of the file, whereas if the last update time point of the file does not lie between the immediately preceding file list collection time point and the latest file list collection time point, the access time point of the file is set as the file time point of the file. When the mark attached to a file in the file list is “updated”the last update time point of the file is set as the file time point of the file, and when the mark attached to a file in the file list is “deleted”, the latest file list collection time point is set as the file time point of the file. FIG. 5 is a view that shows the state in which the file time points were specified by the file time point setting section 105 in the comparison result of the file lists.

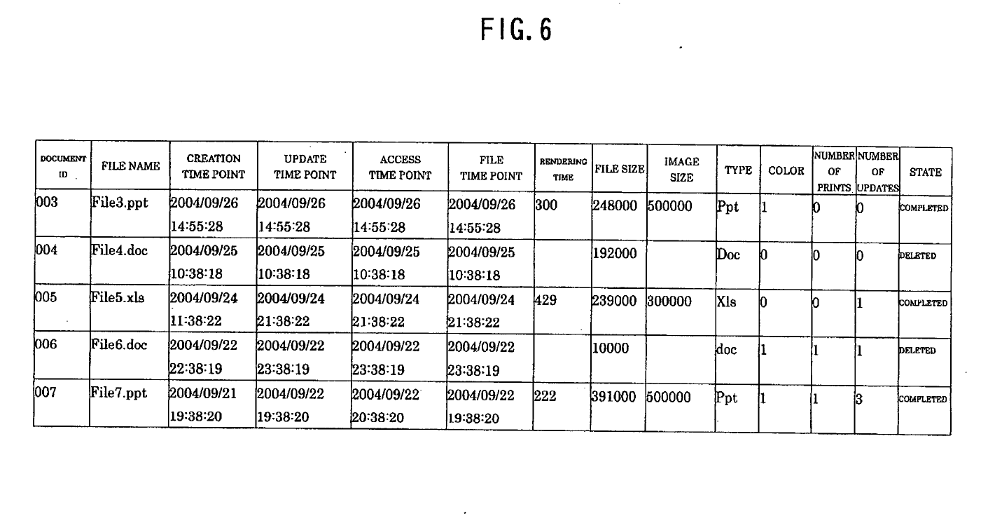

The differences of the file time points specified in the file list are passed to the file management section 106. The file management section 106 updates the information stored in the file information storage section 107 in accordance with the respective “detection” fields. FIG. 6 illustrates details of the information on the files stored in the file information storage section 107. Here, note that file names, file creation time points, the last file updated time points, the last access time points to files, file time points, print image rendering time points, file sizes, print image sizes, file types, color or not, the number of prints of the content of each file, the number of updates of each file, and file states are stored in the file information storage section 107.

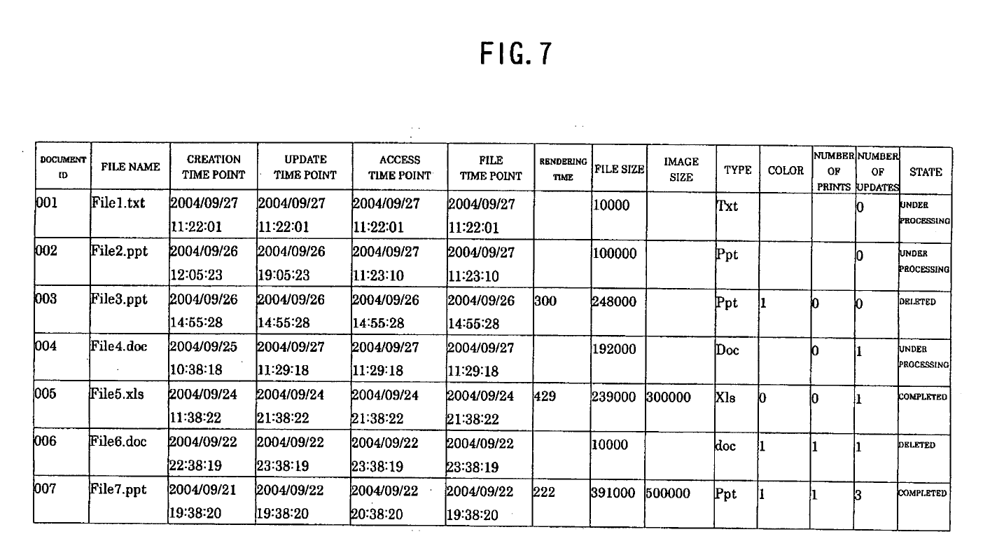

When the comparison result of the file lists as shown in FIG. 5 is acquired, the file management section 106 verifies the “detection” fields, and when a “detection” field is marked with “new”, a corresponding file is registered as a new record and its “state” field is set to “under processing”. When a “detection” field is marked with “updated”, an immediately preceding record for a corresponding file is searched out, and the rendering time, the image size and the color thereof are cleared. Then, the number of updates thereof is increased by one, the time point thereof is updated, and the state thereof is set to “under processing”. When the “detection” field of the file is marked with “deleted”, the “state” field thereof is changed to “deleted”. FIG. 7 illustrates the contents of the file list in a state where the comparison result of the file lists is reflected thereon.

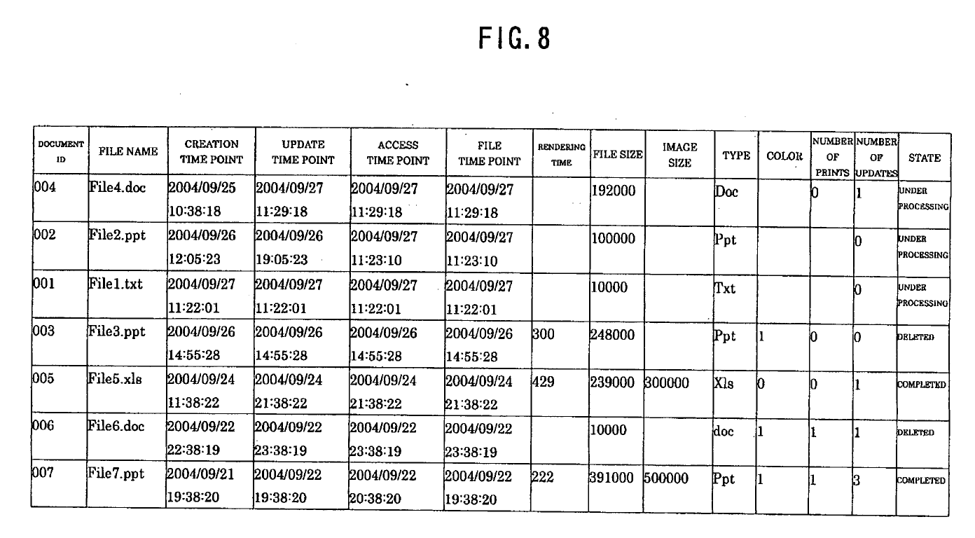

The file management section 106 acquires from the file storage section 102, files whose “state” fields become “under processing”, and sends them to the image data rendering section 108. In addition, the file management section 106 has a function to order or sort the plurality of files based on the file time points among pieces of the file information stored in the file information storage section 107. FIG. 8 is a view that illustrates the file information which is ordered (sorted) according to the file time points by the file management section 106, and which is stored in the file information storage section 107. Thus, the file management section 106 has a role to order or sort a plurality of files based on the specific time points that are set to the plurality of files by the file time point setting section 105.

With an instruction from the file management section 106, the image data rendering section 108 renders a bitmap image (predetermined image data) used for printing a file received from the file storage section 102 via the file management section 106 (an image data rendering step), stores it in the image data storage section 109, and notifies the file management section 106 of the size of the print image file after rendering of the print image, the time required to render the print image, and whether the print image rendered is a color image or a monochrome image.

On the other hand, when an image of an original such as a document, a picture, etc., is read by the image reading section 110 in the form of an MFP, a scanner, a fax receiver, a printer, etc., (an image reading step), image data acquired by the reading is passed to the image storage section 111.

The image storage section 111 stores the image data thus received in the image data storage section 109 as a bitmap image while attaching it with a unique file name (an image storing step), registers a new record in the file management section 106 as a new file, sets all of the file creation time point, the last update time point, the last access time point, and the file time point of the file concerned to the current time, and also sets the “state” field thereof to “deleted”. At this time, the acquisition route or path and the acquisition method of the file can be set together as file information.

The operation input section 112 comprises a keyboard, a mouse, etc., and has a role to receive an operation input such as a file display request from a user and to transmit it to the display management section 113, etc.

The display management section 113 has a role to specify a file to be displayed based on the information registered in the file information storage section 107, to read out necessary image information from the image data storage section 109, and to make it displayed on the display section 114. The display management section 113 stores the file being currently displayed. In the display section 114, a group of files ordered or sorted according to the file time points in the file management section 106 can be displayed based on this order. At this time, in the display section 114, print images (image information) rendered for the plurality of thus ordered files, respectively, by the image data rendering section 108 are displayed on a screen in this order. This screen display of the plurality of files is performed by sequentially switching the print images to be displayed at substantially the same position on the display screen in the display section. Thus, with such a construction in which the ordered files are successively displayed in a predetermined area on the display screen, the user can search for target files in an efficient manner without greatly moving his or her line of sight.

This switching of the print images is carried out by the file management section 106 that receives a user's request for switching the print images displayed on the display section 114 (an instruction for displaying the print images of the preceding file/the following file) through the operation input section 112. The file management section 106 specifies, based on the switching request, the file that should be displayed next to the file whose print images are being currently displayed, so that switched print images are displayed in the predetermined display area in the display section 114 through the display management section 113.

When an activation request is received at the operation input section 112, the display management section 113 specifies the file being currently displayed, and notifies the name of the file to the activation processing section 115.

The activation processing section 115 has a role to specify, upon receipt of the file name (when a request to activate a file corresponding to the image data displayed on the screen by the display management section is received), an application program capable of editing the file, and to activate the application program by designating the file name thereof (an activation step).

Although in this embodiment, the file storage section 102, the list storage section 103, the file information storage section 107, and the image data storage section 109 are constructed so as to be arranged inside the file management apparatus according to this embodiment, the present invention is not limited to this, and at least one of the file storage section 102, the list storage section 103, the file information storage section 107 and the image data storage section 109 can be constructed so as to be arranged in external equipment that is connected to the file management apparatus for communication therewith, or can be constructed so as to be stored in a storage medium such as a CD-ROM, a flexible disk, a DVD disk, a magneto-optical disk, an IC card, etc.

Next, the operation of the file management apparatus according to this embodiment will be described.

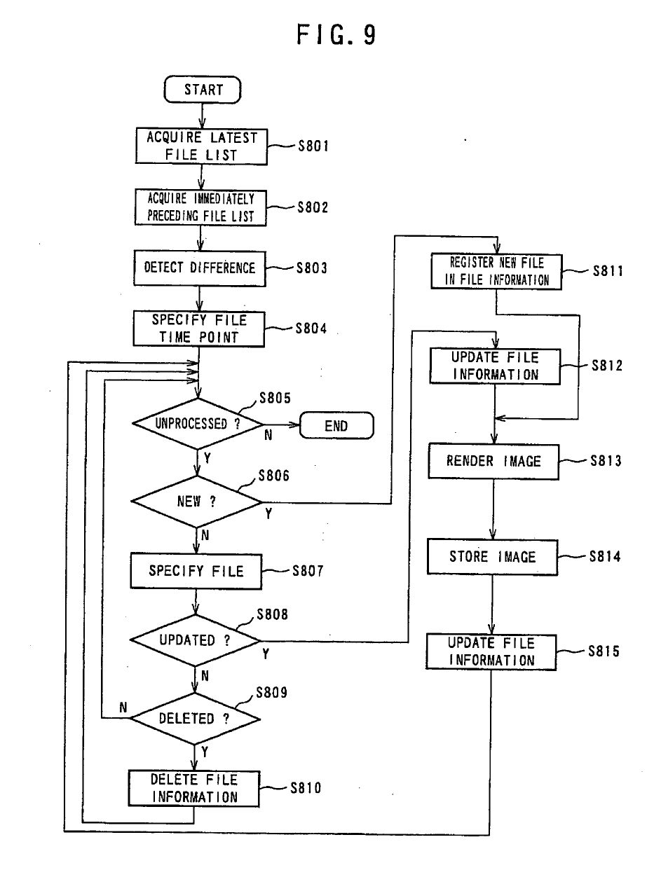

FIG. 9 is a flow chart that illustrates the steps from the detection of update of the files stored in the file storage section 102 until the rendering of print images is completed.

First of all, the list acquisition section 101 acquires the latest file list (S801). Then, the difference acquisition section 104 acquires the immediately preceding file list from the list storage section 103 (S802).

The difference acquisition section 104 makes a comparison between the latest file list and the immediately preceding file list acquired in the above-mentioned steps, and detects a difference their between (S803). The file time point setting section 105 specifies the file time point of each file detected as the difference between the latest file list and the immediately preceding file list (S804). Thus, by automatically specifying the file time points of updated files, even when the system intentionally changes the update dates of files, correct update time points can be acquired.

Subsequently, the print images of the respective files detected as the differences are rendered by the image data rendering section 108 while sequentially recording the files in the file management section 106.

When there still remains any (unprocessed) file for which recording in the file management section 106 and rendering processing of print images have not yet been finished (S805, Yes), a file with its “detection” field in the difference list being marked with “new” (S806, Yes) is registered as a new record in the file information stored in the file information storage section 107 (5811), and the print images of the new file are rendered by the image data rendering section 108 (S813).

Thereafter, the print image data thus rendered by the image data rendering section 108 is stored in the image data storage section 109 (S814), and information on the image size of the print images rendered, the time required to render the print images, and whether the images are colors or monochromes, is recorded in the file information storage section 107, and the “state” field is changed to “completed”. In this manner, the file information is updated, and processing moves to the following file (S815).

When the “detection” field of an unprocessed file is not “new” in step S806 (S806, No), the ID of the file is specified from the file name of the file (S807).

Then, when the “detection” field of the file in the difference list is “updated” (S808, Yes), information on the size of print images, the rendering time of the print images, and the color of the print images stored in the file information storage section 107 is cleared, the update time point is changed to the current value, the file time point is collected to the time point which is specified by the file time point setting section 105, the “state” field is changed to “under processing”, and image rendering from step S813 onwards is performed (S812).

When the “detection” field of the file in the difference list is not “updated” in step S808, it is verified whether the “detection” field is “deleted” (S809), and if “deleted” (S809, Yes), the “state” field of the file in the file information stored in the file information storage section 107 is changed to “deleted” (S810).

When there is no (unprocessed) file for which the recording into the file management section 106 and the rendering processing of print images have not yet been finished (S805, No), processing is terminated.

The file management apparatus according to this embodiment is constructed in such a manner that the image data of a document read by the image reading section 110 is managed as file data and image data by the file management section 106, and the image data thus read is stored in the image data storage section 109 as image data to be displayed on the display section 114. As a result, files including not only those files which were created by PCs, etc., and stored in the file storage section 102 but also the image data of documents read by the image reading section 110 can be managed in a lumped or integrated manner.

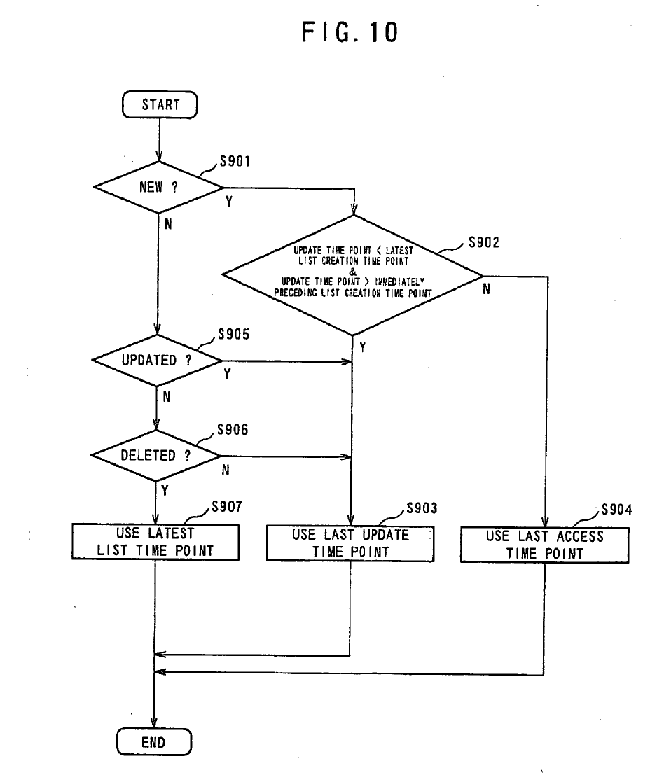

FIG. 10 illustrates a flow chart for explaining in detail the operation of the file time point setting section 105 (S804).

In case where the “detection” field of a file for which the file time point is to be set in the difference list is set as “new” (S901, Yes), when the update time point of the file is between the rendering time point of the latest file list and the rendering time point of the immediately preceding file list (S902, Yes), the last update time point of the file is specified as the file time point thereof (S903). That is, when a change of state in a file detected by the change-of-state detection section is due to a new creation of the file, and when the last update time point of the file, for which the change of state was detected, acquired at the latest timing is later than the time point at which the immediately preceding file information was acquired, the file time point setting section 105 sets the last update time point, which was acquired at the latest timing for the file whose change of state was detected, as a specific time point with respect to the file for which the change of state was detected.

When the update time point of the file is not between the rendering time point of the latest file list and the rendering time point of the immediately preceding file list (S902, No), the last access time point of the file is specified as the file time point thereof (S904). That is, when a change of state in a file detected by the change-of-state detection section is due to a new creation of the file, and when the last update time point of the file, for which the change of state was detected, acquired at the latest timing is earlier than the time point at which the immediately preceding file information was acquired, the file time point setting section 105 sets the last access time point, which was acquired at the latest timing for the file whose change of state was detected, as a specific time point with respect to the file for which the change of state was detected.

On the other hand, in case where the “detection” field of a file for which the file time point is to be set in the difference list is set as “updated” (S905, Yes), the update time point of the file is specified as the file time point (S903). That is, when the change of state of a file detected in the change-of-state detection step is due to the update of the file, the file time point setting section 105 sets the last update time point, which was acquired at the latest timing for the file whose change of state was detected, as the above-mentioned specific time point with respect to the file for which the change of state was detected.

In case where the “detection” field of a file for which the file time point is to be set in the difference list is set as “deleted” (S906, Yes), the time point at which the latest file list was acquired is specified as the file time point (S907). That is, when the change of state of a file detected in the change-of-state detection step is caused by the deletion of the file, the file time point setting section 105 sets the time point, at which file information was acquired at the latest timing, as a specific time point with respect to the file for which the change of state was detected.

As described above, when the update of the states of files stored in the file storage section 102 (creation of a new file, editing of an existing file, etc.) is detected by the change-of-state detection section, the updated contents thus detected are reflected on the file information stored in the file information storage section 107 by means of the file management section 106. The file information list on which the updated contents were reflected is ordered or sorted according to the file time points by the file management section 106 (see FIG. 8), and print images automatically rendered for these files by the image data rendering section 108 are stored in the image data storage section 109. The display management section 113 displays, in its default condition, the print images of a file whose file time point is the latest among a group of the files thus ordered on the display section 114. When a display file switching request such as one for “the following file” or “the previous file” from a user is received by the operation input section 112, the display is switched to the print images of the corresponding file according to the above ordering.

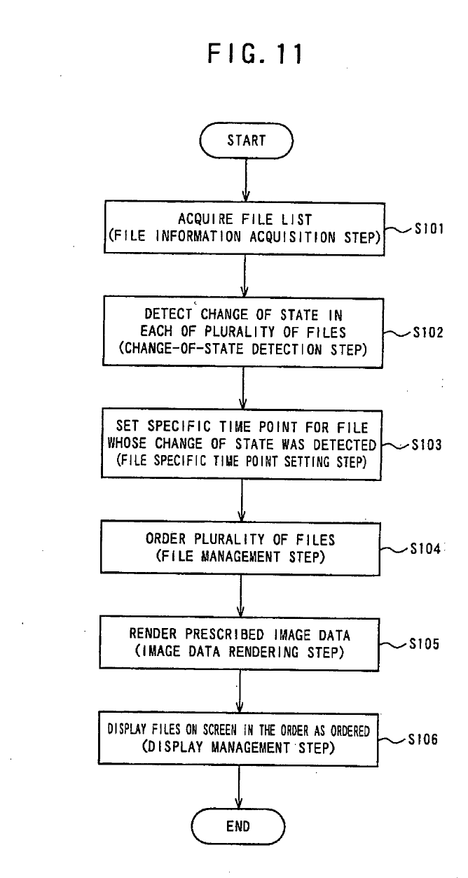

Next, the overall flow of processing in the file management apparatus according to this embodiment will be explained using a flow chart of FIG. 11.

First of all, file information in the form of information on each of a plurality of files to be managed is acquired at predetermined timing from the file storage section 102 by means of the list acquisition section 101 (file information acquisition step) (S101). Preferably, the above-mentioned predetermined timing is regular timing that occurs at preset time intervals, but may be the one based on an operation input of a user or the like.

In a file information acquisition step (S101) the difference acquisition section 104 detects at least either one of new creation, update and deletion as a change of state in each of the plurality of files based on the latest file information acquired at the latest timing and the immediately preceding file information acquired at the timing immediately before the latest timing.

When a change of state has been detected in a change-of-state detection step (S102), a specific time point is set with respect to a file, for which the change of state was detected, based on a predetermined rule corresponding to the change of state (file time point setting step) (S103).

Subsequently, the file management section 106 orders or sorts the plurality of files based on the specific time points set for the plurality of files, respectively, in the file time point setting step (S103) (file management step) (S104). The information on the ordering of the files is stored in the file information storage section 107.

Then, the image data rendering section 108 renders prescribed pieces of image data corresponding to the plurality of files, respectively, based on the file data of the plurality of files (image data rendering step) (S105).

The display management section 113 displays on a screen the plurality of pieces of image data rendered in the above-mentioned image data rendering step (S105) in the order of the files as ordered or sorted in the file management step (S104) (display management step) (S106).

Here, note that in above-mentioned display management step (S106), the plurality of pieces of image data rendered in the image data rendering step (S105) are displayed in a predetermined area (prescribed screen display area) on the display screen of the display section 114 in the order of the files as ordered or sorted in the file management step (S104) in a sequentially switched manner.

The respective steps in the processing of the file management apparatus according to the above-mentioned embodiment are achieved by making the unillustrated control section execute a file control program stored in the unillustrated storage section arranged in the apparatus.

Although in this embodiment, it is constructed such that each group of files managed in the file management apparatus are ordered collectively so that all the ordered files in each group are displayed on the display section 114 in a switched manner, the present invention is not limited to this, but it is needless to say that it can also be constructed such that for example, pieces of file information corresponding to a plurality of users, respectively, are managed by the file management section in such manner that the files managed by a certain user can be displayed on the display section 114 with respect to that user alone. At this time, it can be constructed such that the function to identify the plurality of users, respectively, is possessed by the file management section 106, for example.

In addition, although in this embodiment, the detection of file update in the change-of-state detection section is performed based on information on the time points (for example, the last update time points, etc.) in a file list, the present invention is not limited to this, but for example, update detection can be made by using the hash value of each of the above-mentioned files (based on information on the hash value of each file acquired at the latest timing and information on the hash value of that file acquired at timing immediately before the latest timing) separately from or in combination with update detection-based on information on the time points. In this case, it is preferable that the hash value of each file be stored in the file information storage section 107 as file information.

Although in this embodiment, there has been described the case where functions to achieve the invention are prerecorded in the interior (unillustrated storage section, etc.) of the apparatus, the present invention is not limited to this but similar functions can be downloaded into the apparatus via a network. Alternatively, a recording medium storing therein similar functions can be installed in the apparatus. Such a recording medium can be of any form, such as for example a CD-ROM, which is able to store programs and which is able to be read out by the apparatus. In addition, the functions to be obtained by such preinstallation or downloading can be achieved through cooperation with an OS (operating system) or the like in the interior of the apparatus.

In the file management apparatus according to this embodiment, files are displayed in the order in which the user created/updated the files in their print images that have good viewability and are easy to identify from other files. Therefore, it is possible for the user to find target files if he or she can recognize certain files as such by viewing their print images without recalling any clues. That is, file search can be easily carried out not depending upon file names or the like attached to files respectively (even when file names are automatically given to document files, image files, etc.).

Psychologically, it is widely known that the renewal of recognition (to determine whether something is the one to be searched) is easier than the recalling of memories (to remember something). In addition, it is also known that man's processing power of image processing to determine the layout of a document is higher than that of symbol manipulation or processing to search for a list of file names or classifications Moreover, since the user's memory called an episodic memory serving to keep personal experiences can be made use of for the files that were created/updated by the user in the past, the user holds much information so such a memory is more effective than the recalling of file names.

Specifically, no time and effort is required for file registration work such as file organization, etc., and even if files are updated outside the system, correct update time points thereof can be acquired. Besides, even if a keyword to search for a file is ambiguous or unclear, it is possible to make a search by sequentially viewing the print images of a plurality of files ordered or sorted by the file time points thereof. As a result, the target files can be efficiently found out.

As described in detail in the foregoing, according to the present invention, it is possible to provide a file management apparatus and a file management program which are capable of reflecting, upon occurrence of updates of files in a group of files to be managed, the updates in an appropriate manner without the need to perform complicated or troublesome work, as well as achieving effective file searches irrespective of the kinds or types of the files.

What is claimed is:

1. A file management apparatus comprising:
a file information acquisition section that acquires file information in the form of information on each of a plurality of files to be managed at predetermined timing;
a change-of-state detection section that detects at least either one of new creation, update and deletion as a change of state in each of the plurality of files based on latest file information acquired at latest timing and immediately preceding file information acquired at timing immediately before the latest timing;
a file time point setting section that sets, upon detection of a change of state in any of the files by said change-of-state detection section, a specific time point with respect to the file, for which said change of state was detected, based on a predetermined rule corresponding to said change of state; and
a file management section that orders said plurality of files based on said specific time points that are set to said plurality of files, respectively, by said file time point setting section.

2. The file management apparatus according to claim 1, wherein
said file information includes information on the last update time point and the last access time point of each file; and
when a change of state in a file detected by said change-of-state detection section is caused by a new creation of said file, and when said last update time point of said file, for which said change of state was detected, acquired at said latest timing is earlier than the time point at which said immediately preceding file information was acquired said file time point setting section sets the last update time point, which was acquired at said latest timing for said file whose change of state was detected, as said specific time point with respect to said file for which said change of state was detected.

3. A file management program that makes a computer execute:
a file information acquisition step of acquiring file information in the form of information on each of a plurality of files to be managed at predetermined timing;
a change-of-state detection step of detecting at least either one of new creation, update and deletion as a change of state in each of said plurality of files based on latest file information acquired at latest timing and immediately preceding file information acquired at timing immediately before the latest timing;
a file time point setting step of setting, upon detection of said change of state in said change-of-state detection step a specific time point with respect to the file, for which said change of state was detected, based on a predetermined rule corresponding to said change of state; and
a file management step of ordering said plurality of files based on the specific time points that are set to said plurality of files, respectively in said file time point setting step.

4. The file management program according to claim 3, wherein
said file information includes information on the last update time point and the last access time point of each file; and
when a change of state in a file detected in said change-of-state detection step is caused by a new creation of said file, and when said last update time point of said file for which said change of state was detected, acquired at said latest timing is earlier than the time point at which said immediately preceding file information was acquired, said file time point setting step sets the last update time point, which was acquired at said latest timing for said file whose change of state was detected as said specific time point with respect to said file for which said change of state was detected.

5. The file management program according to claim 3, wherein
said file information includes information on the last update time point of each file; and
when a change of state in a file detected in said change-of-state detection step is caused by a new creation of said file and when said last update time point of said file, for which said change of state was detected, acquired at said latest timing is earlier than the time point at which said immediately preceding file information was acquired, said file time point setting step sets the last update time point, which was acquired at said latest timing for said file whose change of state was detected, as said specific time point with respect to said file for which said change of state was detected.

6. The file management program according to claim 3, wherein
said file information includes information on the last update time point of each file; and
when the change of state of a file detected in said change-of-state detection step is caused by the update of the file said file time point setting step sets the last update time point, which was acquired at said latest timing for said file whose change of state was detected, as said specific time point with respect to said file for which said change of state was detected.

7. The file management program according to claim 3, wherein
when the change of state of a file detected in said change-of-state detection stop is caused by deletion of the file, said file time point setting section sets the time point, at which file information was acquired at said latest timing as said specific time point with respect to said file for which said change of state was detected.

8. The file management program according to claim 3, wherein
said file information includes information on the last update time point of each file; and
said change-of-state detection step of detecting at least either one of new creation, update and deletion as a change of state in each of said plurality of files based on latest file information acquired at said latest timing and immediately preceding file information acquired at timing immediately before said latest timing in said file information acquisition step.

9. The file management program according to claim 3, wherein
said file information includes information on a hash value of each file; and
said change-of-state detection step detects at least either one of new creation, update and deletion as a change of state in each of said plurality of files based on information on the hash value of each file acquired at said latest timing and information on the hash value of each file aoquired at timing immediately before said latest timing in said file information acquisition step.

10. The file management program according to claim 3, wherein
said plurality of files include at least either one of document files, image files, and data files.

11. The file management program according to claim 3. further comprising:
an image data rendering step of rendering prescribed pieces of image data corresponding to said plurality of files, respectively, based on said plurality of files; and
a display management step of displaying on a screen said plurality of pieces of image data rendered in said image data rendering step in the order of the files as ordered in said file management step.

12. The file management program according to claim 3, wherein
said display management step displays in a prescribed screen display area said plurality of pieces of image data rendered in said image data rendering step in the order of the files as ordered in said file management step in a switched manner.

13. The file management program according to claim 3, wherein
prescribed image data rendered in said image data rendering step is bitmap image data used when a file is printed.

14. The file management program according to claim 3, further comprising:
an image reading stop of reading documents; and
an image storage step of storing image data of images read in said image reading step in a predetermined storage area as bitmap image data used when a file is printed.

16. The file management program according to claim 3, further comprising:
an activation step of activating an application capable of editing a file upon receipt of a request to activate the file corresponding to image data displayed on a screen in said display management step.

17. The file management program according to claim 3, wherein
said file information includes at least one of an acquisition method and an acquisition path for each of said plurality of files.
